(19) United States
(12) Patent Application Publication
(10) Pub. No.: US 2009/0220115 A1
(43) Pub. Date: Sep. 3, 2009

(54) Miniature Bio-Compatible Piezoelectric Transducer Apparatus

(75) Inventor: Jean-Francois Lantrua, Hyres (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: AUDIODENT ISRAEL LTD., Omer (IL)

(21) Appl. No.: 12/091,812

(22) PCT Filed: Oct. 23, 2006
(86) PCT No.: PCT/IL2006/001218

§ 371 Date: Oct. 10, 2008

Related U.S. Application Data
(60) Provisional application No. 60/731,233, filed on Oct. 31, 2005.

(51) Int. Cl. H04R 25/00

(52) U.S. Cl. 381/326

(57) ABSTRACT

Vibration transmitting apparatus comprises a vibrating element utilizing a piezoelectric membrane element installed within a bio-compatible sealed case, wherein one end of the piezoelectric element is in static positioned relationship with respect to its casing and the other end is free to move and to vibrate.

### FIELD OF THE INVENTION

The present invention relates to the field of hearing devices. Particularly, the invention relates to electro-acoustic actuators and devices employing them, for use in bone conduction hearing devices and hearing aids.

### BACKGROUND OF THE INVENTION

Bone conduction hearing aids are configured for exciting the cochlea by transmitting vibrations through the skull. Such devices include a vibrating element, which is placed against the skin (usually behind the ear) or in direct contact with the mastoid bone. However, prior art devices have not proven to be satisfactory, since their vibrating element requires tight fixation to the skull and permanent strong pressures in order to be effective in transmitting vibrations to the skull. Consequently, such prior art devices are known to be inefficient and may cause pain or in some cases, epidermal lesions.

Another known technique, used in bone conduction hearing devices, requires a surgical operation in which a permanent titanium fixture or implant is inserted into the skull bone behind the ear. The implant transfers sound vibrations from an external hearing device to the skull.

This technique presents a number of serious medical problems, such as inflammation of the skull bone and adjacent skin and reaction of the bone to vibrations, as well as maintenance issues such as replacement in case of breakdown.

A hearing device utilizing a vibrating element fixed in the user's mouth has been developed and is disclosed in U.S. Pat. No. 5,447,489 to the same applicant hereof. According to this technique, a hearing aid has a transmitter element and a receiver-transducer element having a vibrating element. The receiver element is suitable for being placed, preferably in a removable manner, in the user's mouth, and includes a device for supporting and holding the vibrating element. The device for supporting and holding the vibrating element is formed so that when the vibrating element is in place, it is in permanent contact with at least one tooth or with the palate bone, thereby providing sound transmission to the inner ear by bone conduction. The vibrating element includes a metal plate of small thickness coated on one of its faces with a piezoelectric ceramic, and contained in an envelope constituted by a film of electrically insulating biocompatible polymer. The vibrating element comprises a portion forming a contact block, placed substantially in the center of the element and adapted to come into contact with the tooth while in position of use. Such vibrating element presents two major drawbacks: (i) low efficiency (defined herein as the ratio between the mechanical energy transferred to the tooth or bone and the electrical energy provided to the element) and exposure to oral fluids resulting in corrosion and malfunctions.

There is a need in the art to facilitate the operation and improve the performance of bone conduction hearing devices, especially those for mounting in the patient's oral cavity, by providing a novel electro-acoustic transducer based on piezoelectric elements.

The problems with the known hearing devices of the kind specified above are associated with the following. Piezoelectric elements are commonly used in bone conduction hearing devices and hearing aids as a means for transforming electrical signals to sound. The use of piezoelectric elements in hearing aids was directed to reducing the device size, enhancing its output efficiency and increasing the operative frequency band.

However, it is very difficult to achieve both the small size and the high output. Accordingly, prior art vibrating elements used in hearing devices suffer from several drawbacks, including limited sound gain and significant reduction in sound transfer efficiency (the latter is especially pertinent to high frequencies). The limited sound transducing gain is due to the tradeoff between the size of a piezoelectric element and the energy (sound) that it can generate (hearing aids, especially those that are located in the patient's ear or mouth, are small and therefore have limited sound gain). The reduction in sound transfer efficiency, when placing a piezoelectric element inside the mouth, results from several reasons: (i) if a piezoelectric element is directly placed in the mouth, it may not function properly due to electric short circuit; (ii) if a piezoelectric element is first placed in a case protecting it against humidity, water and sweat, the sound transfer efficiency is reduced; (iii) any space between the teeth and the vibrating element may be obstructed by food or aliments debris; These drawbacks diminish the piezoelectric transducers vibration transmission quality. In fact, current transducers are considered to have mediocre performances when used in hearing devices, particularly, in hearing devices that are placed in the patient's mouth.

### SUMMARY OF THE INVENTION

The invention solves the above problems by providing a novel miniature biocompatible electro-acoustic transducer apparatus. The apparatus includes a vibrating element utilizing a piezoelectric membrane element installed within a sealed case wherein one end of the piezoelectric element is in static positioned relationship with respect to its casing (i.e., it is connected to the case) and the other end is free to move and to vibrate. As will be apparent to the skilled person, the case has to be resistant to its environment, such as to saliva and foodstuff that may come in contact with it. Preferably, the center of mass of the piezoelectric element is closer to its free end than to its fixed end (e.g., the free moving end carries a weight element). The apparatus is small enough to be placed in hearing aids, such as those described in U.S. Pat. No. 5,447,489, and enables efficient sound transfer simply by establishing contact with a vibration-propagating part of the body or prosthesis (a human bone, teeth, or prosthetic element).

Preferably, the piezoelectric transducer element (i.e., that membrane) is configured so as to on the one hand increase the load applied to the contacting element of the body (e.g., tooth) at a given amplitude of vibrations (and thereby increase the output), and on the other hand optimize the natural vibration frequency of the transducer, namely so as to be in the lower part of a hearing frequency range. According to a preferred embodiment of the invention, this is achieved by configuring the transducer element so as to have, in a region thereof at its free moving section, an increased weight as compared to other regions of the transducer element. This may be implemented by appropriately patterning the transducer element to have a specific thickness and/or material distribution (varying relief), or by placing a weight element or load on the free moving section of the transducer.

According to one preferred embodiment of the invention the transducer has a substantially rectangular geometry, but as will be apparent to the skilled person, it may have any suitable different geometry, such as triangular, trapezoidal, or circular configuration with the larger-dimension edge being the free moving one. The transducer is enclosed in a sealed case configured for mounting on a patient's body and in contact with a bone, tooth, or prosthetic element. It should be noted that the weight element may be any load. It may be convenient to use as a weight element the electronics typically required for the hearing device operation, as this may save space, but of course any other suitable type of weight element can be employed.

In the illustrative and non-limitative preferred embodiments described below, the term “membrane/piezoelectric element” used herein signifies a structure including one or more layers of a piezoelectric material supported on a thin layer (e.g., brass). This structure is capable of vibrating in response to a force applied by the piezoelectric layer to the thin supporting layer, which force is created by the deformation across the piezoelectric layer, which is in turn caused by an applied external field.

It should also be noted that the term “free moving” or “free movement” used herein signifies a movement with or without suitable damper means. The device may be configured as a sealed box (case) made of bio-compatible materials incorporating a dedicated vibrating unit, which includes a ceramic piezoelectric membrane element, a fastener for attaching the membrane element to the box at its one end, thereby leaving the other (e.g., heavier-weight) end of the membrane element free for movement (vibration). The apparatus operates with high performance when positioned against the palatal bone, a tooth, or an implant, either by a simple contact, or when attached by hooks, screws, glue or any other means. The size of the apparatus is small enough to be incorporated in hearing aids, in particular of the type that is positioned within a patient's mouth, and typically (but not limitatively), not larger than 20 mm, 10 mm, and 5 mm in correspondingly length, height and width dimensions.

According to one preferred embodiment of the present invention, there is provided a vibrating element for use in an acoustic transducer apparatus of a hearing device, the vibrating element comprising: an elongated piezoelectric membrane element and a fastening means suitable for fixing in place one end of the piezoelectric membrane element and leaving the other end thereof free for vibration.

According to another preferred embodiment of the present invention, there is provided a vibrating element for use in a transducer apparatus of a hearing device, the vibrating element comprising: an elongated piezoelectric membrane element configured to have a weight distribution such as to have the highest weight close to its end, and fastening means configured for fixing in place the other end of the piezoelectric membrane element and leaving said one heaviest-weight end thereof free for vibration.

According to yet another preferred embodiment of the present invention, there is provided an acoustic transducer apparatus for use in a hearing device, the transducer apparatus comprising a vibrating element comprising: an elongated piezoelectric membrane element enclosed in sealed case, and a fastener configured for fixing one end of the piezoelectric membrane element to said case and leaving the other end thereof free for vibration.

In some embodiments of the invention the transducer apparatus comprises a resistant, sealed box, composed of bio compatible materials, and the vibrating element including a ceramic piezoelectric vibrator in the form of an elongated membrane fixed by one of its ends to the supporting box, while the movement of the free end is enhanced by a weight. The box is designed to host fixation elements. The vibrating piezoelectric membrane may be covered by a thin film of resin. All the electronic elements (e.g., those needed for the reception and amplification of the audio signal) are preferably integrated into the box.

### BRIEF DESCRIPTION OF THE DRAWINGS

Illustrative and non-limitative examples of preferred embodiments of the invention will now be described with reference to the accompanying drawings, in which:

FIGS. 1 to 7 describe the invention when implemented in a tight case, which follows the shape and contour of the vibrating element:

FIG. 1 shows the case in a tight implementation (i.e., in which the casing closely follows the shape of the vibrating element);

FIG. 2 is a transparent view showing the placement of the vibrating element within the case;

FIG. 3 is a vertical cross-section of the apparatus of FIG. 1;

FIG. 4 is a top view of the apparatus of FIG. 1;

FIG. 5 shows the vibrating element;

FIG. 6 is a vertical cross-section of a device of FIG. 1, in which the electronic elements also function as a weight element; and

FIG. 7 is an illustrative general view of the apparatus when installed on the teeth.

FIGS. 8 to 12 describe the invention when implemented in a simple rectangular case:

FIG. 8 is an illustrative general view of the apparatus when installed on the teeth;

FIG. 9 is showing the case in which the vibrating element is placed;

FIG. 10 and FIG. 11 show the vibrating element with a weight on its free vibrating end; and

FIG. 12 is an enlargement of the free end of the vibrating element showing a weight element;

### DETAILED DESCRIPTION OF PREFERRED EMBODIMENTS

As will be apparent to the skilled person, the transducer apparatus of the present invention may have different shapes and forms. The detailed description and related figures provided herein show, as a non-limiting example, a “tight” implementation of the invention, in which an external case carrying an internal vibrating element is formed to closely follow the contour of the internal vibrating element. As will be easily apparent to the skilled person, other shapes, such as substantially rectangular box-like casings, in which more space is provided between the vibrating element and the wall of the casing, can be provided, as well as many other different shapes, e.g., triangular, trapezoidal, elliptical, circular, double-bell shaped or dumbbell-shaped, with the larger-dimension edge being the free moving end. Such evident alternative shapes are not described herein in detail, for the sake of brevity.

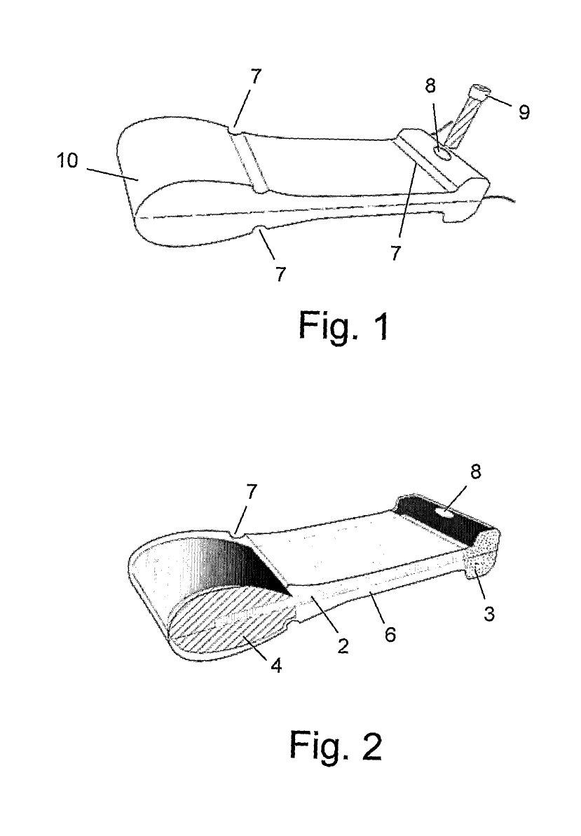

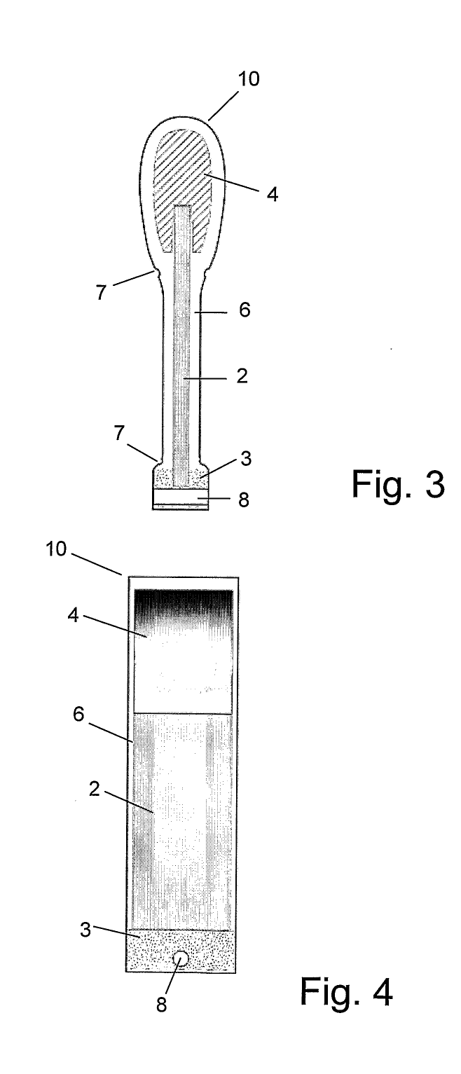

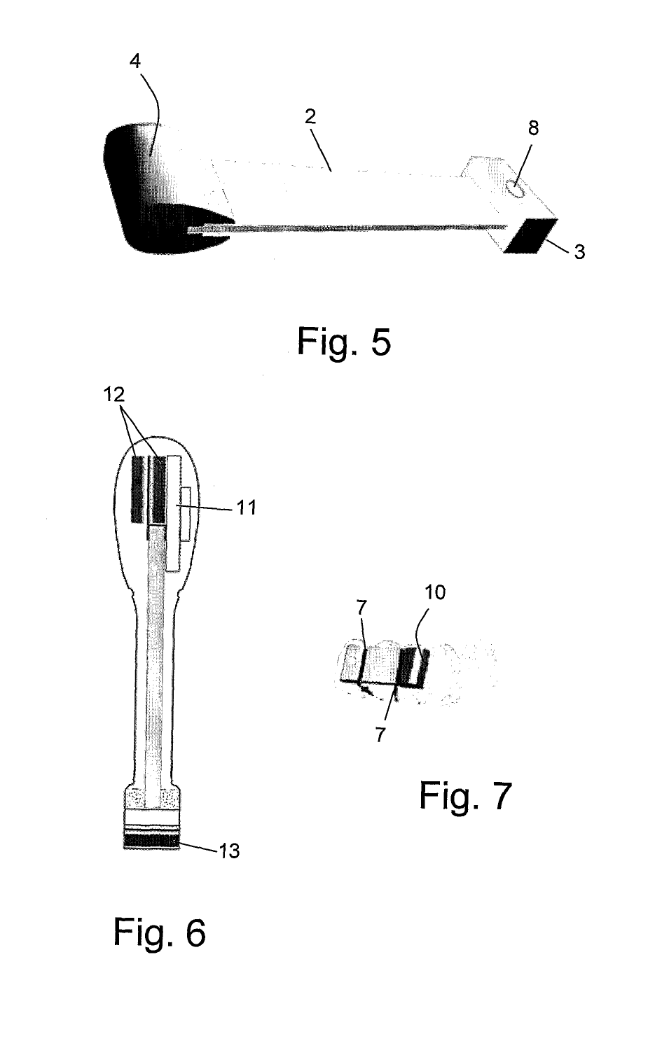

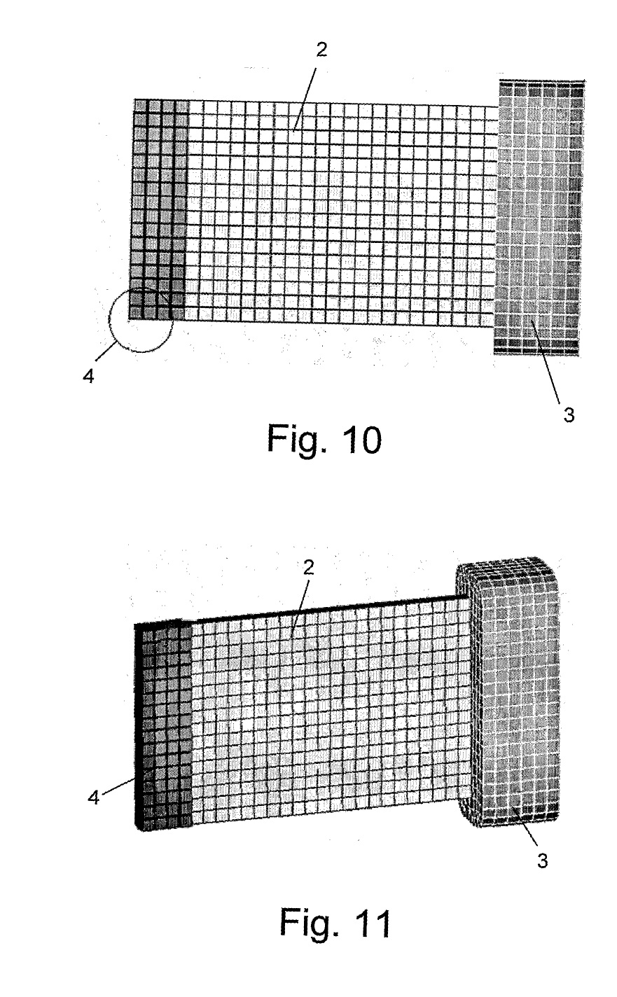

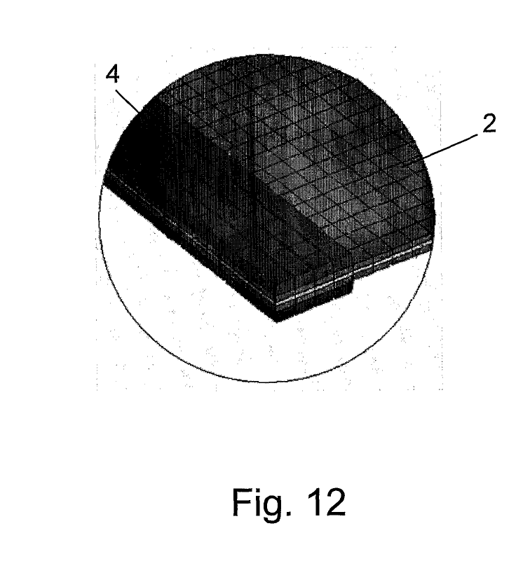

Referring to FIGS. 1-12, there are shown examples of a vibrating element, which is formed by an elongated piezoelectric membrane element 2, and a fastener (fixation block) 3, associated with one end of the membrane element 2, so as to fix this end in place while leaving the opposite end free to vibrate. In the present example, the membrane element 2 is of rectangular shape. It should however be noted that the invention is not limited to this specific example or to any particular shape. The membrane element may, for example, be of a substantially triangular or trapezoidal cross-section, such that the edge of the membrane element having a larger width is the vibrating one.

As shown in the figures, the vibrating element is located in a sealed case 10. The membrane element 2 is fixed by one of its ends to case 10, through which the vibrations of the other end (i.e., the load created thereby) are transmitted. The piezoelectric element 2 is fixed to the case by means of fixation block 3, which includes an elastic isolating material (e.g. epoxy, acrylic adhesive) attaching the respective end of the membrane element to the inner surface of the case. It should be noted, although not specifically shown, that this fixation block also carries electrical connectors for the signal transmission to and from the piezoelectric element.

Preferably, the performance of the transducer apparatus is increased by configuring the piezoelectric element so as to have the highest weight at the free moving end thereof. As shown in the present non-limiting example, this is implemented by providing a weight element 4 at the free end of the piezoelectric element. The weight 4 may be made of metal (e.g. gold); its shape and mass distribution are optimized to produce a neutral point of vibration and frequency response of the device and increase the gain in the chosen frequency range.

The piezoelectric membrane element may be covered by a thin film of a resin material (e.g. epoxy) to prevent damage or breakage in case of shock. The piezoelectric element 2, the weight 4, and the fixation block 3, assembled together form the vibrating element.

The piezoelectric element 2 is connected to electronic circuitry, which provides electrical signals to the element, using isolated and sealed wires. The required electronic circuitry may be attached to the transducer case 10 from the outside, or may be placed within the case. Incorporating the electronic circuitry within the transducer case requires, inter alia, incorporation of a small battery (e.g., a rechargeable battery). As shown in FIG. 6, incorporating the battery and other electronics elements within the case 10 may be implemented by positioning at least some of the electronic circuitry elements in a separate compartment 13 at the fixed end of the piezoelectric element 2, or by using the weight 4 to include the electronic circuitry elements 11 or 12). When the electronic circuitry is located inside the case, the vibrating element of the transducer apparatus placed in the sealed case 10 becomes an autonomous device, integrating all the elements required for the device operation (including for example reception and amplification of the audio and/or electric signal, which may implemented via connecting wires or by wireless signal transmission).

As shown in the example of FIGS. 1-7, the shape of the case 10 follows that of the internal vibrating element. As indicated above, the sealed case may be of any other suitable shape, e.g., a substantially rectangular shape.

The case 10, also called the external box, is comprised of one or more biocompatible materials, such as polycarbonate or stainless steel or titanium, and may be of a simple rectangular-box shape or may have a complex shape approximately following the shape of the vibrating element, while leaving enough space (as illustrated by numeral 6 in FIGS. 2-4) for the vibrating element to vibrate freely without hitting the case itself.

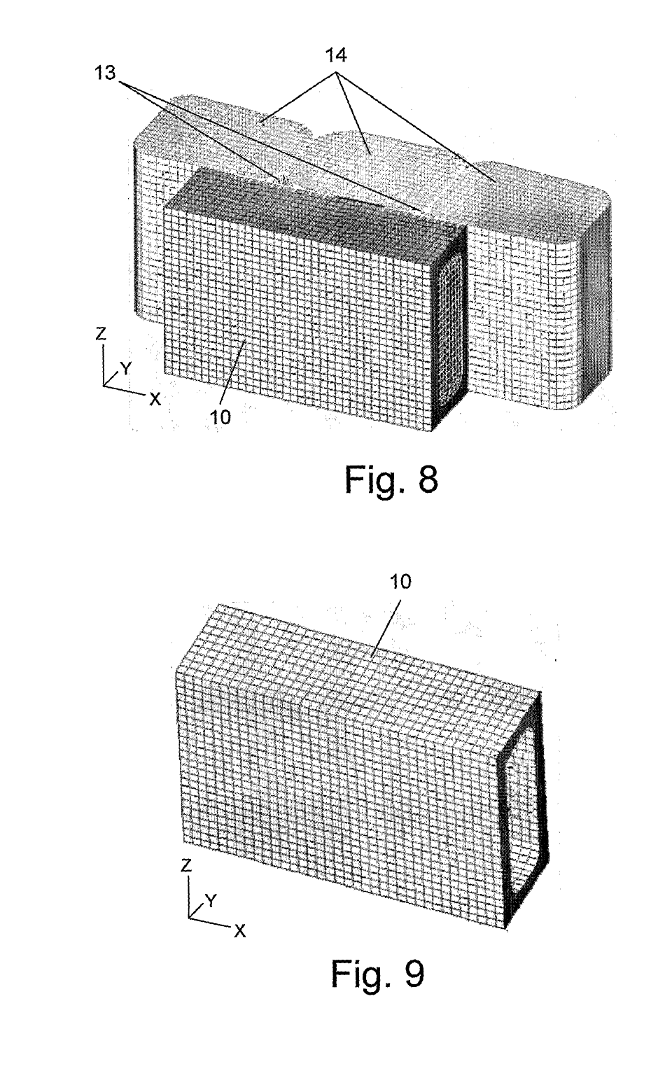

The case 10 is held in its place (i.e. a bone, prosthetic element or teeth to which sound vibrations are transmitted) by means of a holding arrangement. In the present example, grooves 7 (FIG. 1) are provided for accurate positioning of the case on the teeth, as shown in the example of FIG. 7. Alternatively, with reference to FIG. 8, fixation brackets 13 (not shown in detail in the figure) can be used to fix the acoustic system to teeth 14.

A typical piezoelectric element structure includes one or more layers of a piezoelectric material (e.g., two layers of piezo-ceramic) supported on a thin layer (e.g., brass), enclosed between the two piezo-ceramic layers. Also, in the present example, the weight element (4 in FIGS. 1-6 and 10-12) is provided, which is constituted by mass layers sandwiching the respective end of the piezoelectric element therebetween. This structure is capable of vibrating in response to a force applied by the piezoelectric layer(s) to the thin supporting layer, which force is created by the deformation across the piezoelectric layer(s), which is in turn caused by an applied external field.

The results of a computerized mechanical analysis (simulations), carried out to evaluate the apparatus performance and to compare it with alternative piezoelectric element based structures, with or without weight on its end, demonstrate the advantages of using the proposed apparatus (vibrating element). The analysis tested (i) the utmost movement of the piezoelectric element; (ii) The maximum load on the tooth, which represents the sound transfer efficiency of the tested device (the higher the load on the tooth, the higher is the efficiency) and (iii) the natural vibration frequency (resonance frequency), which is an important device characteristic used in sound applications, particularly in hearing devices, as it is the frequency in which the device provides its maximum output.

The results demonstrate the advantages of using the proposed apparatus: while having approximately the same maximum displacement when bent, the element described in the present invention, puts a significantly larger (five to ten fold) load on a tooth and its natural frequency is lower than that of other piezoelectric elements.

The electro-acoustic transducer of the present invention may be packaged in a way that allows using it in the human body, in particular in the oral cavity or in the ear canal, leaving the piezoelectric membrane protected from humidity, water, sweat. The transducer provides for high sound transfer efficiency, allowing its use as part of hearing aids.

1. A vibration transmitting apparatus, comprising a vibrating element utilizing a piezoelectric membrane element installed within a sealed case, wherein one end of the piezoelectric element is in static positioned relationship with respect to its casing and the other end is free to move and to vibrate.

2. The vibration transmitting apparatus according to claim 1, wherein the mass of the vibrating element is not evenly distributed along the piezoelectric element.

3. The vibration transmitting apparatus according to claim 1, which is of a size such that it can be contained in hearing aids while enabling efficient sound transfer by establishing contact with a vibration-propagating part of the body or prosthesis, such as a human bone, teeth, or prosthetic element.

4. The vibration transmitting apparatus according to claim 1, wherein the piezoelectric transducer element is configured so as to increase the load applied to the contacting element of the body at a given amplitude of vibrations, thereby to increase the output, and to optimize the natural vibration frequency of the transducer so as to be in the lower part of a hearing frequency range.

5. The vibration transmitting apparatus according to claim 4, wherein the configuring is performed by providing a transducer element having, in a region thereof at its free moving section, an increased weight as compared to other regions of the transducer element.

6. The vibration transmitting apparatus according to claim 5, wherein the increased weight is provided by appropriately patterning the transducer element to have a specific thickness and/or material distribution, or by placing a weight element or load on the free moving section of the transducer.

7. The vibration transmitting apparatus according to claim 1, wherein the transducer has geometry selected from among substantially rectangular, triangular, trapezoidal, elliptical, circular, double-bell shaped or dumbbell-shaped, with the larger-dimension edge being the free moving end.

8. The vibration transmitting apparatus according to claim 6, wherein the weight element comprises the electronics typically required for the hearing device operation.

9. The vibration transmitting apparatus according to claim 1, wherein the case in which the piezoelectric membrane element is located is made of resistant bio-compatible material, enabling it to be used within the mouth, ear or other body parts.

10. The vibration transmitting apparatus according to claim 1, wherein all the electronic elements sufficient for the reception and amplification of audio signals are all integrated within the apparatus' case.

11. The vibration transmitting apparatus according to claim 1, wherein the apparatus is used in a transducer apparatus of a hearing device.
